(19) United States
(12) Patent Application Publication
(10) Pub. No.: US 2008/0095090 A1
(43) Pub. Date: Apr. 24, 2008

(54) OPERATION MODE CONTROL APPARATUS AND METHOD FOR A MOBILE TERMINAL

(75) Inventors: Byong Mo LEE, Busan Metropolian City (KR); Jeong Hyo YI, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/858,867

(22) Filed: Sep. 20, 2007

(30) Foreign Application Priority Data
Oct. 24, 2006 (KR) 10-2006-0103191

(51) Int. Cl. G08C 17/00

(52) U.S. Cl. 370/311

(57) ABSTRACT

An operation mode control apparatus and method for a mobile terminal includes transitioning, if a packet is received at the dormant state, from the dormant state to the active state; determining, if a packet is received at the active state, whether the packet is an unsolicited packet; discarding, if the packet is an unsolicited packet, the packet and transitioning to the dormant state; and maintaining, if the packet is a solicited packet, the activate state.

### CROSS REFERENCE TO RELATED APPLICATIONS

This application claims priority from and the benefit of Korean Patent Application No. 10-2006-0103191, filed on Oct. 24, 2006, which is hereby incorporated by reference for all purposes as if fully set forth herein.

### BACKGROUND OF THE INVENTION

1. Field of the Invention

The present invention relates to a mobile communication system and, in particular, to an operation mode control apparatus and method for a terminal of the mobile communication system.

2. Discussion of the Background

Telecommunication systems may be classified into wired and wireless systems. In a wired system, terminals exchange data through wired communication lines. Whereas, in a wireless system, terminals exchange data through radio channels. The wireless communication system enables mobility of the terminals. The mobile terminals have evolved to support both data communication service and conventional voice communication service.

Because most mobile terminals are battery powered, the operating time of a mobile terminal depends on the capacity of an attached battery and the power consumption rate of the mobile terminal. To increase the operating time of the mobile terminal, it is necessary to increase the capacity of the attached battery or reduce the power consumption rate of the mobile terminal.

Typically, the development of battery lifetime extension technology has been very slow; hence, the development of a low power consumption technology is more desirable for increasing the operating time of the mobile terminal. For this reason, research and development for reduced power consumption devices and circuit structures has increased.

Another approach to reducing power consumption is to efficiently manage operation modes of the mobile terminal. Typically, the mobile terminal operates in an active and a dormant state defined by mobile communication standards and regulations.

The active state is an operation mode in which the mobile terminal communicates with another terminal so that physical elements of the mobile terminal are activated, resulting in higher power consumption.

The dormant state is an operation mode in which the mobile terminal is in standby. In the dormant state, the mobile terminal alternates between periods of not listening for any radio traffic and listening for radio traffic to reduce power consumption.

FIG. 1 is a schematic block diagram illustrating a conventional mobile communication system.

Referring to FIG. 1, the mobile communication system includes mobile terminal 100 and base station 140, which enables mobile terminal 100 to access network services over the air interface. Mobile terminal 100 transmits information to base station 140 through uplink channel 120. Uplink channel 120 includes an uplink control channel, a data channel, etc. Base station 140 transmits information to mobile terminal 100 through downlink channel 110. Downlink channel 110 includes a downlink control channel, a common channel, a paging channel, a data channel, etc. Other types of channels exist for uplink and downlink transmission, and the channels may be referred to by different terms depending on the communication system.

In the active state, mobile terminal 100 and base station 140 communicate data through at least one of downlink channel 110 and uplink channel 120. When there is no data to be exchanged between mobile terminal 100 and base station 140, mobile terminal 100 enters the dormant state to minimize power consumption.

A transition procedure between the active state and dormant state is described below.

Generally, if a packet is not received before an inactive timer has expired in the active state, the mobile terminal 100 enters the dormant state, i.e. mobile terminal 100 transitions from the active state to the dormant state.

If a packet is received in the dormant state, mobile terminal 100 transitions to the active state regardless of the validity of the received packet.

Normally, the inactivity timer is set to 20 seconds. However, in some systems, the inactivity timer is set to a shorter time (for example, 5 seconds). This technique focuses on the quick transition from the active state to the dormant state by reducing the counts of the inactive timer.

The shortened inactivity timer-based state transition method, however, is designed without a process for a validity check of the received packet. Thus, an unsolicited packet and solicited packet are dealt with in the same manner. Mobile terminal 100 in the dormant state transitions to the active state upon receiving any packet. Accordingly, the conventional state transition method has the drawback that the mobile terminal 100 unnecessarily wakes up from the dormant state and occupies a traffic channel even when an unsolicited packet is received, resulting in a waste of network resources.

### SUMMARY OF THE INVENTION

The present invention provides a mobile communication system including an operation mode control apparatus and method for a terminal of the mobile communication system which may prevent transition of a terminal from a dormant state to an active state upon receipt of an unsolicited packet of data.

Additional features of the invention will be set forth in the description which follows, and in part will be apparent from the description, or may be learned by practice of the invention.

The present invention discloses an operation mode control method for a mobile terminal that alternately operates in an active state and a dormant state. The method includes transitioning, if a packet is received at a dormant state of the mobile terminal, from the dormant state to an active state if the packet is a solicited packet; determining, if the packet is received at the active state, whether the packet is an unsolicited packet; discarding, if the packet is an unsolicited packet, the packet and transitioning to the dormant state; and maintaining, if the packet is a solicited packet, the active state.

The present invention also discloses an operation mode control method for a mobile terminal that alternately operates in an active state and a dormant state. The method includes starting, at the active state, a timer for transitioning to the dormant state; determining whether a packet is received before the timer expires; recording a count value of the timer when the packet is received; performing, at a network layer, a first validity check on the packet; resetting, if the packet passes the first validity check, the timer; and adding, if the packet fails the first validity check, a time taken for a packet delivery into the network layer and the first validity check on the packet, to the recorded count value.

The present invention also discloses an operation mode control apparatus for a mobile terminal that alternately operates in an active state and a dormant state. The apparatus includes a network layer and a transport layer. The network layer performs, if a first packet is delivered from a data link layer at the dormant state, a first validity check on the first packet; outputs, if the first packet passes the first validity check, the first packet; and discards, if the first packet fails the first validity check, the first packet and maintain the dormant state. The transport layer performs, if the first packet is delivered from the network layer, a second validity check on the first packet; transitions, if the first packet passes the second validity check, to the active mode; and maintains, if the first packet fails the second validity check, the dormant state.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention are incorporated in and constitute a part of this specification, illustrate embodiments of the invention, and together with the description serve to explain the principles of the invention.

FIG. 1 is a schematic block diagram illustrating a conventional mobile communication system.

FIG. 2 is a diagram illustrating an Open Systems Interconnection (OSI) reference model in association with a mobile terminal according to an exemplary embodiment of the present invention.

FIG. 3 is a flowchart illustrating an operation mode control method according to an exemplary embodiment of the present invention.

FIG. 4 is a flowchart illustrating an operation mode control method according to another exemplary embodiment of the present invention.

FIG. 5 is a flowchart illustrating a method for operating a time and compensation value according to another exemplary embodiment of the present invention.

### DETAILED DESCRIPTION OF THE ILLUSTRATED EMBODIMENTS

The invention is described more fully hereinafter with reference to the accompanying drawings, in which embodiments of the present invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

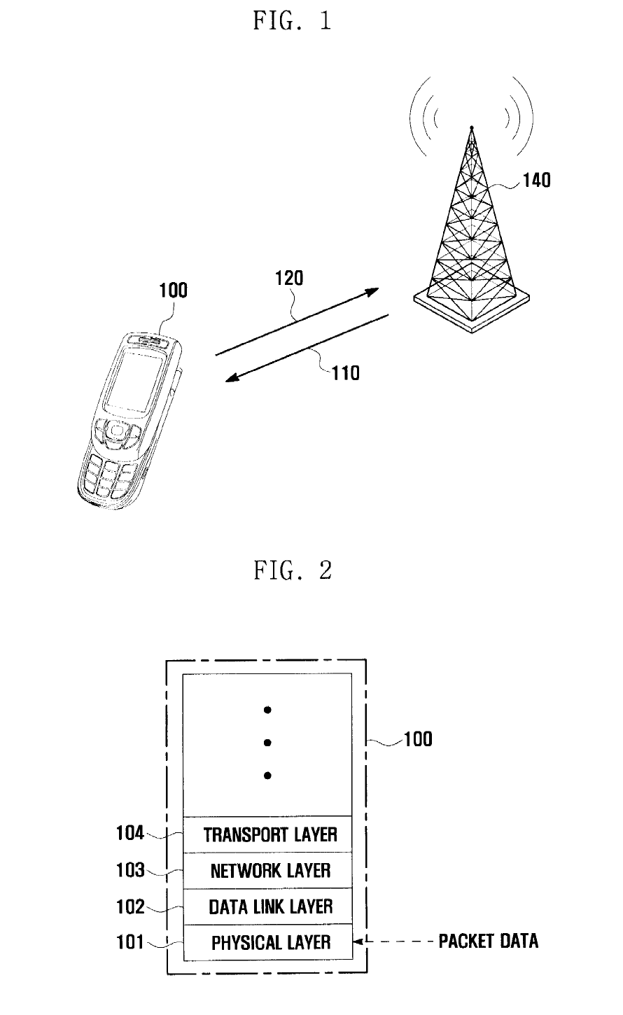

FIG. 2 is a diagram illustrating an Open Systems Interconnection (OSI) reference model in association with a mobile terminal according to an exemplary embodiment of the present invention.

Referring to FIG. 2, packet data transmitted from a base station is received by physical layer 201. Physical layer 201 performs down-converting, demodulating, and decoding on the received packet data and then transfers the decoded packet data to data link layer 202. Thus, physical layer 201 physically converts the received data. The converted data is processed at data link layer 202. Data link layer 202 includes a Roaming Location Protocol (RLP) layer, which performs automatic repeat requests, network connection, and flow control in cooperation with a radio link control protocol.

The data processed at data link layer 202 is delivered to network layer 203. A network layer protocol data unit includes logical address information so that the network layer 203 can determine whether the data is successfully addressed on the basis of the logical address.

The successfully received data is delivered to transport layer 204. Transport layer 204 performs segmentation on the data from lower layers and combines the received data, and is further responsible for end-to-end error recovery and flow control.

The OSI reference model further includes a session layer, a presentation layer, and application layer above the network layer, which are not depicted in FIG. 2 nor described herein because they are outside the scope of the present invention.

In the present invention, if a packet is received in the dormant state, whether mobile terminal 200 transitions to the active state depends on whether the packet was solicited. Here, network layer 203 and the transport layer 204 determine whether the received packet is a solicited packet. If the packet is a solicited packet, mobile terminal 200 transitions from the dormant state to the active state. If the packet is not solicited, the mobile terminal 200 maintains the dormant state. The RLP layer cannot determine whether the packet is a solicited packet. Rather, the network layer 203 and the transport layer 204 check the solicitation.

A packet that passed the first check at the network layer 203 may be verified as an unsolicited packet at transport layer 204 because network layer 203 checks for an “invalid protocol” and transport layer 104 checks for an “invalid packet” of Transmission Control Protocol (TCP), User Datagram Protocol (UDP), and Internet Control Message Protocol (ICMP). Network layer 203 and transport layer 204 may regard the following cases as unsolicited packets:

(1) Some TCP broadcasts are considered as unsolicited IP message;

(2) An invalid TCP segment;

(3) Any invalid UDP packet; and

(4) A packet with an invalid protocol.

Two cases are considered below. In the first case, the inactivity timer has expired so that the mobile terminal is in a dormant state when it receives a packet. In the second case, the inactivity timer has not expired. Thus, in the second case, the mobile terminal is in an active state when it receives a packet.

Thus, a packet may be received after the previously received packet is verified as an invalid packet so that mobile terminal 200 enters the dormant state, or before the previously received packet is checked (for example, when packets are sequentially received).

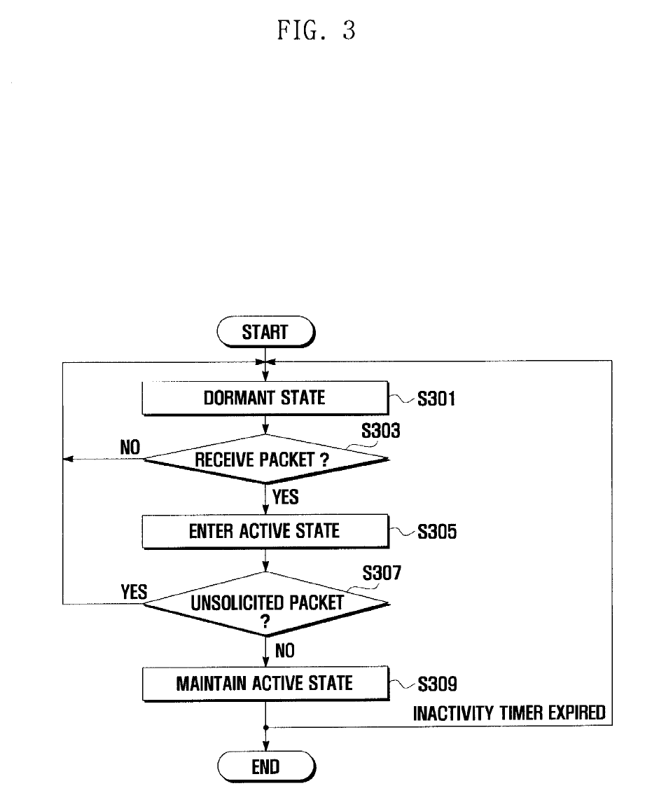

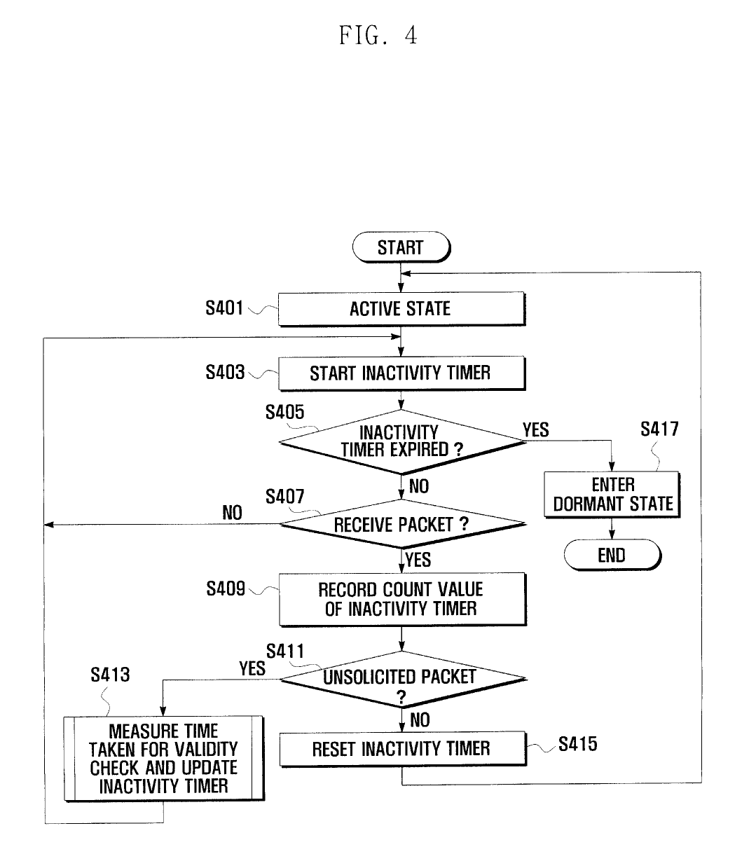

FIG. 3 is a flowchart illustrating an operation mode control method according to an exemplary embodiment of the present invention. A mode control procedure for mobile terminal 200, which receives a packet in the dormant state, is described hereinafter with reference to FIG. 2 and FIG. 3.

As described above, when the inactivity timer expires, mobile terminal 200 enters the dormant state (S301). In the dormant state, network layer 203 determines whether packet data is delivered from physical layer 201 and data link layer 202 (S303). Transport layer 204 monitors delivery of packets from network layer 203. If a packet is not delivered from the lower layers, the process returns to step S301. If a packet delivered from the lower layers is detected, network layer 203 transitions from the dormant state to the active state (S305).

At this time, mobile terminal 200 checks whether a packet is delivered from the lower layers to network layer 203, and, if a packet is delivered, data encapsulated in the packet is delivered from network layer 203 to transport layer 204.

After entering the active state, network layer 203 and transport layer 204 sequentially perform validity checking on the packet (S307). If a packet is delivered from data link layer 202 to network layer 203, network layer 203 checks the validity of the packet. If the packet is valid, network layer 203 delivers the packet to transport layer 204; where it is checked by transport layer 204. If the packet is not valid, the process proceeds to step S301, maintaining the network in the dormant state.

If it is determined that the packet is valid in network layer 203, network layer 203 delivers the packet to transport layer 204. Transport layer 204 verifies the packet again. The validity check, at step S307, is performed at network layer 203 and transport layer 204. If the received packet is verified as a valid packet, mobile terminal 200 maintains the active state before the inactivity timer expires (S309); and enters the dormant state (S301) when the inactivity timer has expired. On the other hand, if the received packet is determined as an invalid packet, the process goes back to the state S301.

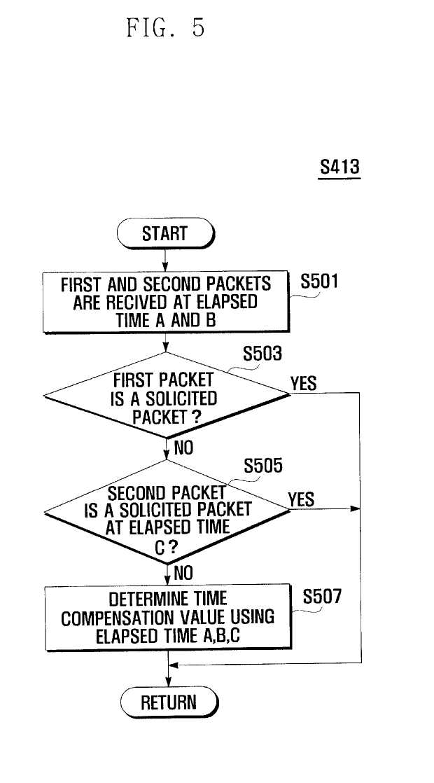

FIG. 4 is a flowchart illustrating an operation mode control method according to another exemplary embodiment of the present invention. A mode control procedure for mobile terminal 200 receiving a packet in the active state is described below with reference to FIG. 2 and FIG. 4.

Referring to FIG. 4, a mobile terminal 200 in the active state (S401) starts an inactivity timer upon receiving a last packet (S403). The inactivity timer may be set to a specific value (for example, 5 or 20 seconds).

After the inactivity timer starts, mobile terminal 200 determines whether the inactivity timer has expired (S405). If the inactivity timer has expired, mobile terminal 200 enters the dormant state (S417).

If the inactivity timer has not expired, mobile terminal 200 determines whether a packet is received (S407). This process is similar to the process for the exemplary embodiment described in FIG. 3. Thus, mobile terminal 200 checks whether it received a packet is delivered from the lower layers to network layer 203, and data encapsulated in the packet may be delivered from network layer 203 to transport layer 204.

If no data is delivered from network layer 203, mobile terminal 200 returns to the step S403. If data is delivered from network layer 203, mobile terminal 200 makes a backup of the value of the inactivity timer (S409). The backup is stored in a memory.

Next, mobile terminal 200 checks the validity of the packet to determine whether the received packet is invalid (S411). The validity check process is similar to the process described above with reference to FIG. 3. If it is determined that the received packet is valid (solicited), mobile terminal 200 resets the inactivity timer (S415) and repeats the step S401 to maintain the active state. If the received packet is invalid (unsolicited), mobile terminal 200 measures a time taken for the validity check and resets the invalidity timer to an updated value obtained by subtracting the measured time from an initial value of the invalidity timer (S413), and then repeats step S403 with the updated value.

More specifically, when receiving an invalid packet, mobile terminal 200 updates the value of the inactivity timer with the elapsed time count at the time when the last-received packet passes the RLP layer. Thus, the validity of the packet is not verified even though the inactivity timer starts counting at the time when the packet passes the RLP layer, because the upper layer checks the validity. Accordingly, a difference between the time points when the packet passes the RLP layer and the upper layer should be compensated. The time compensation algorithm operates as described below.

Referring to FIG. 5, it is assumed that first and second packets are sequentially received at elapsed times A and B at the RLP layer (S501). Mobile terminal 200 determines whether a first packet is a solicited packet (S503). If the first packet is determined to be an unsolicited packet, mobile terminal 200 determines whether the second packet is a solicited packet for the upper layer at elapsed time C (S505). At time C, the last-received packet, i.e. the second packet, is used for determining the time compensation value.

Thus, the time compensation value is determined using the difference between the elapsed times C and B. Accordingly, the inactivity timer is updated with a value obtained by adding the time compensation value to the elapsed time A (S507).

The inactivity timer is updated taking in consideration the processing delay time because the network layer 203 and transport layer 204 rather than at physical layer 201 and data link layer 202 check the validity.

The operation mode control method of the present invention may prevent the sojourn time at the active state from being elongated by compensating the delay time taken to check the validity of the unsolicited packet.

As described above, an operation mode control apparatus and method for a mobile terminal may prevent, at a dormant state, occurrence of a state transition to an active state due to an unsolicited packet; and at the active state, an elongation of the active state by an unsolicited packet, thereby avoiding waste of network resources and reducing power consumption of the mobile terminal.

Although exemplary embodiments of the present invention have been shown and described in detail hereinabove, it should be clearly understood that many variations and/or modifications of the basic inventive concepts taught herein, which may appear to those skilled in the present art, will still fall within the scope and spirit of the present invention. Thus, it is intended that the present invention cover the modifications and variations of this invention provided they come within the scope of the appended claims and their equivalents.

What is claimed is:

1. An operation mode control method for a mobile terminal that alternately operates in an active state and a dormant state, comprising:
transitioning, if a packet is received at a dormant state of the mobile terminal, from the dormant state to an active state;
determining, if the packet is received at the active state, whether the packet is an unsolicited packet;
discarding, if the packet is an unsolicited packet, the packet and transitioning to the dormant state; and
maintaining, if the packet is a solicited packet, the active state.

2. The operation mode control method of claim 1, wherein determining whether the packet is an unsolicited packet comprises:
performing, at a network layer, a first validity check on the packet; and
performing, at a transport layer, a second validity check if the packet passes the first validity check.

3. The operation mode control method of claim 2, wherein the first validity check determines whether the packet comprises a valid protocol.

4. The operation mode control method of claim 2, wherein the second validity check determines whether the packet is a valid packet.

5. The operation mode control method of claim 3, wherein the valid protocol comprises a transmission control protocol, a user datagram protocol, and an internet control message protocol.

6. The operation mode control method of claim 2, wherein performing a first validity check comprises:
determining whether the packet comprises an invalid protocol; and
discarding, if the packet is of the invalid protocol, the packet and transitioning to the dormant state.

7. The operation mode control method of claim 2, wherein performing the second validity check comprises:
determining whether the packet is an invalid packet;
discarding, if the packet is an invalid packet, the packet and transitioning to the dormant state; and
maintaining, if the packet is a valid packet, the active state.

8. The operation mode control method of claim 2, further comprising:
maintaining, if the packet is a solicited packet, the active state until an inactivity timer expires; and
transitioning to the dormant state when the inactivity timer expires.

9. An operation mode control method for a mobile terminal that alternately operates in an active state and a dormant state, comprising:
starting, at the active state, a timer for transitioning to the dormant state;
determining whether a packet is received before the timer expires;
recording a count value of the timer when the packet is received;
performing, at a network layer, a first validity check on the packet;
resetting, if the packet passes the first validity check, the timer; and
adding, if the packet fails the first validity check, a time taken for a packet delivery into the network layer and the first validity check on the packet, to the recorded count value.

10. The operation mode control method of claim 9, further comprising:
performing, at a transport layer, a second validity check on the packet if the packet passes the first validity check;
resetting, if the packet passes the second validity check, the timer; and
adding, if the packet fails the second validity check, a compensation value to the recorded count value.

11. The operation mode control method of claim 10, wherein the compensation value is obtained by subtracting the time between a time when the packet passes a data link layer and a time when the packet passes an upper layer.

12. The operation mode control method of claim 11, wherein adding a compensation value to the recorded count value comprises:
receiving a first packet and a second packet sequentially;
determining whether the first packet and the second packet are solicited packets;
calculating the compensation value using a time taken to determine a validity of the second packet and a time at which the second packet is received; and
adding the compensation value to a time when the first packet is received to obtain an updated timer value.

13. An operation mode control apparatus for a mobile terminal that alternately operates in an active state and a dormant state, comprising:
a network layer to perform, if a first packet is delivered from a data link layer at the dormant state, a first validity check on the first packet; to output, if the first packet passes the first validity check, the first packet; and to discard, if the first packet fails the first validity check, the first packet and maintain the dormant state; and
a transport layer to perform, if the first packet is delivered from the network layer, a second validity check on the first packet; to transition, if the first packet passes the second validity check, to the active mode; and to maintain, if the first packet fails the second validity check, the dormant state.

14. The operation mode control apparatus of claim 13, further comprising:
an inactivity timer; and
a memory for storing a value of the inactivity timer when the first packet is received before the inactivity timer expires.

15. The operation mode control apparatus of claim 14, wherein the network layer performs, if a second packet is delivered from a data link layer at the active state, the first validity check on the second packet; measures the time taken for the first validity check and for reception of the second packet; and updates the inactivity timer using the measured time.

16. The operation mode control apparatus of claim 14, wherein the network layer resets the inactivity timer if the first packet passes the first validity check.

17. The operation mode control apparatus of claim 14, wherein the transport layer performs the second validity check, if the first packet is delivered from the network layer; measures the time taken for the second validity check and to receive the first packet; and updates the inactivity timer using the measured time.

18. The operation mode control apparatus of claim 17, wherein the transport layer resets the inactivity timer if the first packet passes the second validity check.
